(19) United States
(12) Patent Application Publication
(10) Pub. No.: US 2009/0187513 A1
(43) Pub. Date: Jul. 23, 2009

(54) SYSTEMS AND METHODS FOR UPFRONT VEHICLE PRICING

(75) Inventors: Oded Noy, Los Angeles, CA (US); Scott Painter, Los Angeles, CA (US); Tom Taira, Santa Monica, CA (US); Karim O'Driscoll, Los Angeles, CA (US); Kevin Burkett, West Hollywood, CA (US)

Correspondence Address: WILSON SONSINI GOODRICH & ROSATI, 650 PAGE MILL ROAD, PALO ALTO, CA, 94304-1050, US

(73) Assignee: Zag.com Inc., a Delaware Corporation, Santa Monica, CA (US)

(21) Appl. No.: 12/179,164

(22) Filed: Jul. 24, 2008

Related U.S. Application Data
(60) Provisional application No. 61/022,798, filed on Jan. 22, 2008.

(51) Int. Cl. G06Q 30/00

(52) U.S. Cl. 705/400

(57) ABSTRACT

Systems and methods for upfront vehicle pricing management may include an independently owned online system which may provide a consumer with an upfront dealership price for a vehicle trim as a category. A vehicle pricing management system may collect vehicle pricing information from multiple sources, provide pricing feedback information, and provide alerts for various pricing changes. Dealers and other non-broker entities may be able to interact with the system and submit dealership prices, and may receive real-time feedback in terms of price effectiveness for the dealer and yield of consumer buy-in.

### CROSS-REFERENCE

This application claims the benefit of U.S. Provisional Application No. 61/022,798 filed Jan. 22, 2008, which application is incorporated herein by reference.

### FIELD OF THE INVENTION

This invention is directed to systems and methods of upfront vehicle pricing management. The invention may include an online system which may provide a consumer with an upfront dealership price for a vehicle as a category. In addition, the invention may collect vehicle pricing information from multiple sources, provide pricing feedback information, provide alerts for various pricing changes, and allow dealerships to adjust their prices displayed accordingly.

### BACKGROUND OF THE INVENTION

Today, the Internet is a useful tool for purchasing vehicles. An important factor in the purchase considerations is the pricing of the vehicle. Many factors may go into determining a price: manufacturer pricing guidelines, dealer actual costs, the size of available inventory, and the market demand for the vehicle to name a few.

Online car brokers may provide consumers with their broker prices for particular types of vehicles. However, these broker prices may not reflect actual dealership prices and brokers may have to find a dealership that will provide a vehicle that will meet that price. Additionally, if a broker finds a dealership that will provide a lower price than the broker price cited to a consumer, the consumer may not receive the benefit of the lower dealership price. In such situations, when a consumer may purchase a vehicle at a broker price, the consumer may not be certain whether the consumer is receiving the lowest price the consumer could have received from among the dealerships.

Sometimes dealerships may provide dealership prices to consumers for particular vehicles. These vehicles are often listed as actual specified vehicles, including identifying information such as a VIN number. However, such vehicles may sell out quickly, which may prevent a consumer from receiving the quoted price, or a consumer may not wish to purchase the specific listed vehicle.

There is a need for improved systems and methods of vehicle pricing management that may incorporate multiple sources of pricing data and enable dealerships to provide an upfront dealership price to consumers for vehicle categories.

### SUMMARY OF THE INVENTION

The invention provides systems and methods for upfront vehicle pricing management. Various aspects of the invention described herein may be applied to any of the particular applications set forth below or for any other types of online pricing systems or methods. The invention may be applied as a standalone system or method, or as part of an integrated business arrangement relating to pricing management for online sales of products or services. It shall be understood that different aspects of the invention can be appreciated individually, collectively, or in combination with each other.

One aspect of the invention is directed to systems and methods for upfront vehicle pricing management. A vehicle pricing management system may include an online system not owned or operated by a dealership or dealership parent company, which may provide a consumer with an upfront dealership price for a vehicle as a category. In addition, the invention may collect vehicle pricing information from multiple sources, provide pricing feedback information, and provide alerts for various pricing changes. Dealerships or other sellers that are not brokers may be able to interact with the vehicle pricing management system to adjust their prices or to determine what information may be displayed.

Vehicle price to a consumer may be determined by a dealer that may sell a vehicle to the consumer. A dealer or dealership may include any entity selling a vehicle that is not a broker. The dealer may consider one or more factors in order to determine a price, such as the manufacturer pricing guidelines, the dealer actual costs, the size of available inventory, and the market demand for the vehicle to name a few. A dealer may set its target pricing using the online tools provided by a vehicle pricing management system and consumers may receive upfront pricing from the dealer. The vehicle pricing management system may be owned and operated independently by a party other than a dealership or dealership parent company.

Setting an upfront dealership price may require the consideration of several factors. The vehicle pricing management system may have the ability to collect vehicle pricing information from multiple sources and to create a normalized dataset based on these sources so that they can be compared. For instance, the system may collect vehicle pricing information from manufacturers, dealerships, the Internet market, and other sources.

The vehicle pricing management system may have the capability to calculate the price displayed to a consumer on the web site based on a base vehicle price. The base vehicle price may be a price set for a vehicle trim, which may be a base model of a vehicle being sold as identified by the manufacturer. This price may not include any options or other fees associated with the vehicle. The vehicle pricing management system may then add the appropriate cost for options that may be configured on the vehicle. Options may include ad-ons to a vehicle that may be available via a dealership. The calculated prices may not apply to specific items in inventory, but rather to a theoretical vehicle that may exist in inventory (i.e. the pricing may apply to more than one possible physical vehicles).

In addition, the vehicle pricing management system may have the ability to include a calculation of dealer fees, destination charges, and other pricing variances that may apply to a vehicle at a designated dealership.

A vehicle pricing management system may include a mechanism for a dealership to enter and update its pricing for each type of vehicle it may sell. In one embodiment of the invention, the vehicle pricing management system may interact with dealerships through a dealer portal. The dealer portal may be a web enabled system that may provide a dealer with secure access to pricing information. It may also include a set of tools that may enable the dealer to update its pricing. In addition to allowing dealerships to request price changes, the vehicle pricing management system may provide information to the dealer, such as pricing information from multiple sources. The system may also display to the dealer a suggested or target price, which may be the price suggested by the vehicle pricing management system as the most favorable for the dealership in terms of price and yield of consumer buy-in. The system may provide feedback to the dealer in real-time as to a price's effect on sales.

In one embodiment of the invention, a vehicle pricing management system may include a vehicle pricing management application which can be used by system pricing administrators to accept dealer price requests, reject them, post notes back to the dealer, and update aspects of target pricing.

The vehicle pricing management application may have the ability to administer additional fees associated with a vehicle, such as destination charges, advertising fees, docking fees, and other dealership fees. For any such pricing elements the application may enable the pricing administrator to determine which prices will be incorporated into the upfront dealership price, and which will be displayed as a line item (rather than a part of a hidden calculation for the price).

The vehicle pricing management application may also have the ability to administer information regarding price incentives that may apply to a vehicle before the final price of the vehicle is calculated. Some of the incentives may be visible to a consumer on a consumer website; some incentives may be hidden from the consumer, as a special arrangement between the manufacturer and the dealership. In some cases, a dealership may specify whether to display information about incentives to consumers.

Additionally, the vehicle pricing management application may have the ability to block certain vehicles from being displayed with pricing to consumers upon a dealer's request, or a dealer's inability to provision the blocked vehicle at a competitive price. In addition, the application may have the ability to tag specific pricing items, so that a consumer website could be configured to display various messages based on the configuration.

The vehicle pricing management system may also include an alert mechanism that can automatically inform all system users that may be interested in a price change (such as a consumer, dealer, or pricing administrator) about any change in any vehicle price that they may have indicated interest in. The alert mechanism may inform interested parties about changes in dealership price, or about changes in manufacturer or suggested price.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 illustrates an implementation of the vehicle pricing management system on a computer system.

FIG. 2 shows a barebones vehicle pricing management system where consumer websites and a dealer portal may communicate with a vehicle pricing management system.

FIG. 3 illustrates how the data may be stored in a vehicle pricing management system.

FIG. 4 illustrates data flow within a vehicle pricing management system.

FIG. 5 illustrates data flow for pricing change within a vehicle pricing management system.

### DETAILED DESCRIPTION OF THE INVENTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for upfront vehicle pricing management. A vehicle pricing management system may include an online system which may provide a consumer with an upfront dealership price for a vehicle as a category. In addition, the invention may collect vehicle pricing information from multiple sources, provide pricing feedback information, and provide alerts for various pricing changes. Dealers may be able to interact with the vehicle pricing management system to adjust their prices or to determine what information may be displayed.

The vehicle pricing management system may not be owned or operated by a dealership or dealership parent company. In some cases, the vehicle pricing management system may not be owned or operated by a business entity associated with a dealership. An independent entity may provide upfront prices from various sources for vehicle categories.

An upfront dealership price may be an upfront, direct price which may be provided from a source. A source may be a dealership or any entity who is not a broker offering to sell a vehicle at a set, no-hassle price. Such sources may herein be referred to as dealers or dealerships and may include, in addition to dealerships, sellers that are not dealerships or brokers. An upfront dealership price may be an actual vehicle price, and may not include broker fees.

An upfront dealership price may be provided for a vehicle as a category. A vehicle category may refer to a theoretical vehicle rather than a specific item in inventory. For example, a vehicle category may refer to a base model of a vehicle being sold, such as a Honda Civic. In a preferable embodiment, a vehicle category may include a base model plus trim, such as a Honda Civic LX. A vehicle category may also include a base model or trim with options, such as a Honda Civic LX with moon roof and upgraded tires. In some cases, there may be more than one physical specific vehicle that may belong to a vehicle category. For example, a dealership may have three different specific vehicles with three different VIN numbers that may each be a Honda Civic LX with moon roof and upgraded tires, and may be within the same vehicle category. In another example, an upfront dealership price may be provided for the vehicle category of a four-door Honda Civic LX, of which a dealership may have one or more physical specific vehicles with different VIN numbers.

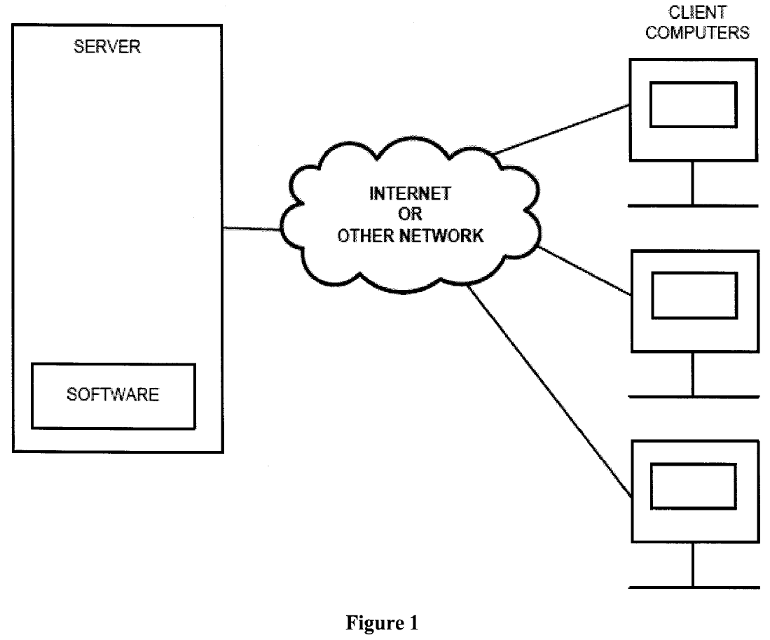

FIG. 1 illustrates an implementation of the vehicle pricing management system on a computer. A vehicle pricing management system may be implemented using a system comprising a client computer, a server operably connected to the client computer, and a database coupled to the server to store data. The server may be operably connected across a network to a client computer. In some embodiments of the invention, one or more servers can be connected across a network to one or more client computers. The network, for example, can include the Internet or any network for connecting a client to a server. The client computer can have a video display and a user interface presented on the video display for allowing user interaction with the system. For example, consumer websites and dealer portals may be displayed on client computers.

In one implementation of the invention, a computer file or data residing in memory can be transmitted from a server over a network to a client computer and stored in memory by the client computer. At the client computer, the computer file or data may be interpreted by software residing in memory on the client computer, causing the computer file or data to be displayed as a display page on a video display in a manner perceivable by a user. A display page described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a display page from a computer file or data on a video display in a manner perceivable by a user. Where a network comprises the Internet, a display page may comprise a webpage of a type known in the art.

In an alternate embodiment of the invention, the vehicle pricing management system may be implemented on a client computer. The computer file or data may reside and be stored in memory on the client computer. Alternatively, the system may be implemented on any computer system known in the art, such as peer to peer systems, and so forth.

A display page according to the invention may include embedded functions comprising software programs stored in memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, a frame, a window, a scroll bar, a button, an icon, and a hyperlink, and well known features such as a “point and click” interface. Pointing to and clicking on a graphical user interface button, icon, or hyperlink also is known as “selecting” the button or hyperlink. A display page according to the invention also may incorporate multimedia features. The display page may enable user interaction with a vehicle pricing management system. For example, a display page may be a consumer website or a dealer portal.

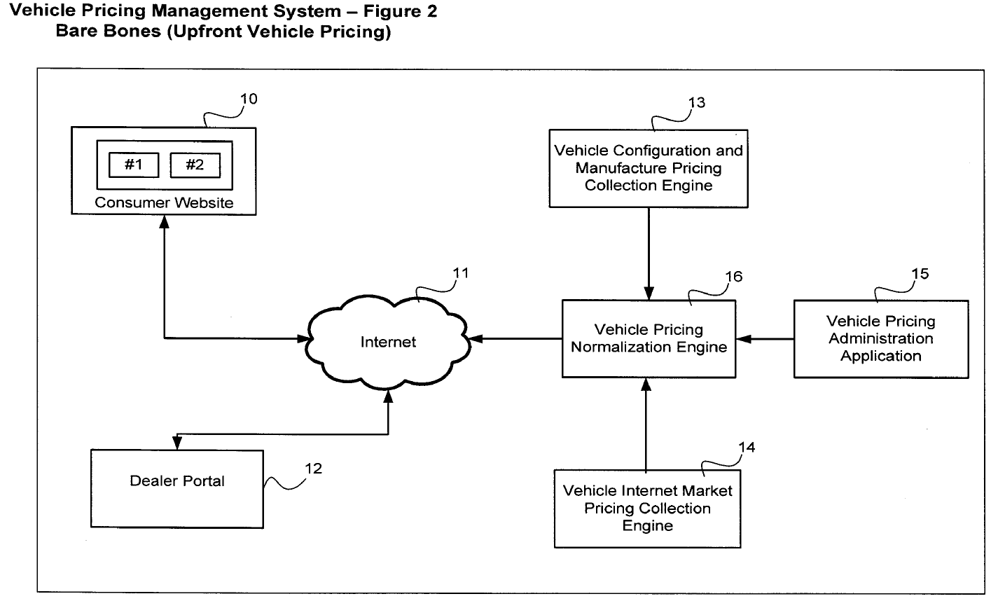

FIG. 2 shows a barebones vehicle pricing management system. One or more consumer websites 10 may communicate with a vehicle pricing management system over a network such as the Internet 11. A dealer portal 12 may also provide an interface for a vehicle pricing management system over the Internet 11. A dealer portal 12 may be a web enabled system that can provide a dealership with secure access to pricing information. The portal may also include a set of tools that may enable the dealership to update its pricing, update dealership information, determine what information may be visible to consumers, determine information configurations, receive feedback for various prices, and perform other activities.

The vehicle pricing management system may include a vehicle configuration and manufacture pricing collection engine 13, a vehicle Internet market pricing collection engine 14, a vehicle pricing administration application 15, and a vehicle pricing normalization engine 16. The vehicle configuration and manufacture pricing collection engine 13 may look at a manufacturer prices for a vehicle, such as the manufacturer's suggested retail price (MSRP) for a particular vehicle trim and at other manufacturer prices such as invoice prices at which manufacturers may provide as guidelines to dealerships. The vehicle configuration and manufacture pricing collection engine 13 may also incorporate manufacturer prices for various vehicle options that may be added to particular vehicle trims. Vehicle options may be add-ons to a vehicle that may be available via a dealership. This process may also incorporate industry wisdom, such as the cost to add particular options to a vehicle trim. The vehicle configuration and manufacture pricing collection engine 13 may have pricing information for the various combinations of vehicle trims with particular options.

The vehicle Internet market pricing collection engine 14 may incorporate how a market for a particular vehicle category, such as a vehicle model or trim, behaves. It may collect data on market conditions from multiple sources, including the vehicle pricing management system and other available sources. Data collection could be done via data feeds, or via web crawling for information that is published on the Internet. It may also include data which may allow the vehicle pricing management system to provide feedback to the dealer in real-time as to a price's effect on sales. Such data may include the ratio between the vehicle pricing to the effect on the leads, walk-ins to the dealerships, and close rate of the perspective buyer based on a set price.

A vehicle pricing management system may have the ability to display upfront pricing for a consumer based on his or her geographic location and the location of participating dealers. For example, the vehicle pricing management system may automatically assign an online consumer to a set of designated dealerships based on criteria which may include considerations such as the consumer's location, distance to the dealership and the price range for the selected vehicle. Additionally, the vehicle pricing management system may provide options to a consumer such as designating an acceptable geographic area or acceptable price range.

The vehicle pricing administration application 15 may incorporate additional fees associated with a vehicle, such as destination charges, advertising fees, docking fees, and other dealership fees. The vehicle pricing management system may have access to this additional fee data and may factor it into the upfront dealership price of the vehicle presented before a consumer. For example, the pricing administrator may determine which prices will be incorporated into the upfront dealership price, and which will be displayed as a line item rather than a part of a hidden calculation for the price. Alternatively, a dealer may determine which items may be visible to a consumer. In some cases, there may be a default as to which fees are automatically visible to a consumer and which are not.

The vehicle pricing administration application 15 may also have the ability to administer information regarding pricing incentives that may apply to a vehicle. The incentives may apply to a vehicle before the final price of the vehicle is calculated. The vehicle pricing management system may have access to incentives information and may factor it into the upfront dealership price. Incentives may be visible to a consumer or a consumer website. Alternatively, incentives may be hidden from the consumer, as a special arrangement between the manufacturer and the dealership. In some cases, some incentives may be visible to a consumer while other incentives may not. Dealerships may specify whether to display information about incentives to consumers. Similarly, a pricing administration may determine which incentives may be incorporated into the upfront dealership price, and which may be displayed as a line item, rather than part of a hidden calculation.

In addition to determining which pricing items may be displayed, a vehicle pricing management system may have the ability to block certain vehicles from being displayed with pricing to consumers upon a dealer's request. For example, a dealer may have an inability to provision the blocked vehicle at a competitive price, and may not wish for the dealer's blocked vehicle price to be displayed to consumers. In another example, a pricing administrator may choose to block a dealer's vehicle price. In addition, the system may have the ability to tag specific pricing items, so that a consumer website may be configured to display various messages based on the configuration.

The vehicle pricing normalization engine 16 may receive the information from multiple sources, which may include manufacturers, dealerships, market data, additional charges, and so forth. Such data from the vehicle configuration and manufacture pricing collection engine 13, the vehicle Internet market pricing collection engine 14, and the vehicle pricing administration application 15 may be normalized by the vehicle pricing normalization engine 16. It may normalize the data so that the information may have a standard format, which may make it easier to compare vehicle prices. The vehicle pricing normalization engine 16 may examine the pricing information under various criteria. It may convey the various pricing information along with any analysis to a dealership and may assist the dealership to determine pricing.

A vehicle pricing management system may provide a dealer with a suggested or target price based on the collected pricing information. A suggested or target price may be the price suggested by the system as being the most favorable for the dealership in terms of price and yield of consumer buy-in. Alternatively, different criteria may define a suggested price. Such criteria may define a price that may be favorable to a dealership in different ways. The system may provide feedback to the dealer in real-time about how the suggested price may play in the market, such as the ratio between the vehicle pricing to the effect on the leads, walk-ins to the dealerships, and close rate of the perspective buyer based on a given price so that a pricing setting may be most informed.

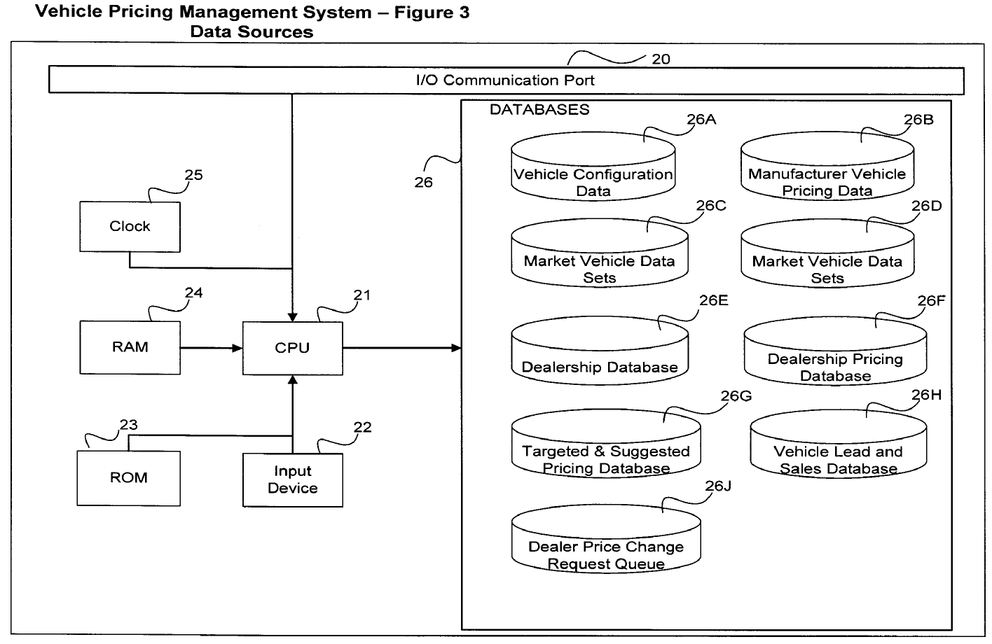

FIG. 3 illustrates how the data may be stored in a vehicle pricing management system. An input/output communication port 20 may enable communication between multiple sources of pricing information and a vehicle pricing management system. In some cases, the input/output communication port 20 may enable communication between dealers or consumers and a vehicle pricing management system. The input/output communication port 20 may communicate with a central processing unit (CPU) 21. The CPU 21 may also communicate with an input device 22, ROM 23, RAM 24, a clock 25, and databases 26.

The databases 26 may store information relevant to vehicle pricing management. Databases 26 may include information collected from many sources. Vehicle configuration data relating to vehicle trims and available options may be stored in a vehicle configuration database 26A. A vehicle trim may be a base model of a vehicle being sold as identified by the manufacturer. Options may include add-ons to a vehicle that may be available (or in some cases may be mandatory) via a dealer. Some examples of options may include a moon roof, premium audio package, upgraded tires, and so forth.

Manufacturer prices for a vehicle trim and available options may be stored in a manufacturer vehicle pricing database 26B. Market pricing information gathered from multiple sources may be stored in market vehicle data sets 26C, 26D. Market pricing information may or may not include Internet market pricing information. There may also be a dealership database 26E which may identify and include any information about participating dealerships.

A dealership pricing database 26F may include dealership prices for various vehicle trims and available options. The vehicle pricing management system may have the capability to provide a price to a consumer on the web site based on a base vehicle price. The base vehicle price may be a price set for a vehicle trim. This price may not include any options or other fees associated with the vehicle. The vehicle pricing management system may then add the appropriate cost for options that may be configured on the vehicle. The calculated prices may not apply to specific items in inventory, but rather to vehicle categories.

Based on all the information collected, a vehicle pricing management system may have targeted and suggested prices for various vehicle trims and options in various geographic locations. A targeted or suggested price may be a price suggested by the system as optimal for the dealership in terms of various criteria such as price and yield of consumer buy-in. Such information may be stored in a targeted and suggested pricing database 26G.

There may also be a vehicle lead and sales database 26H which may include information about how pricing relates to sales. It may enable a vehicle pricing management system to provide feedback to a dealer in real-time as to the effect of pricing on sales. The vehicle lead and sales database 26H may include information such as the ratio between the vehicle pricing to the effect on the leads, walk-ins to the dealerships, and close rate of the perspective buyer based on a set price. This may enable consumer behavior to affect suggested vehicle pricing.

Any time an industry source has a price change, dealerships and other parties (i.e. consumers, vehicle pricing management administration) may be alerted, and a change in price may be reflected in the appropriate databases. For instance, a change in manufacturer pricing may affect the manufacturer vehicle pricing database, which may affect the targeted and suggested pricing database. In one embodiment of the invention, a system pricing administrator may update target pricing aspects. A dealer may decide to change price in accordance with any other change in price information, or for any arbitrary reason. A dealer request to change a price may be stored in a dealer price change request queue 26J. In some embodiments, vehicle pricing management administration may review the dealer price change request and may determine whether to grant the price change. A system pricing administrator may accept dealer pricing, reject dealer pricing, or post notes back to the dealer. Alternatively, change requests in a dealer price change queue 26J may automatically be granted without undergoing review by an administrator.

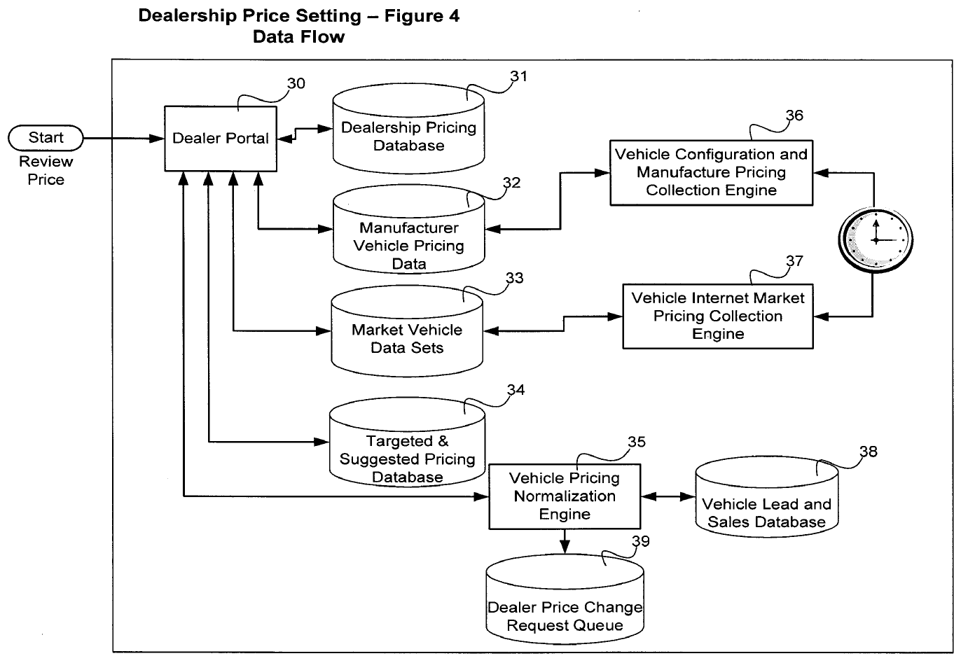

FIG. 4 illustrates data flow within a vehicle pricing management system. A dealer may interact with a dealer portal 30 which may show a variety of pricing information from multiple sources. A dealer may review a price through the dealer portal 30. The dealer portal 30 may receive information from a dealership pricing database 31, a manufacturer vehicle pricing database 32, market vehicle data sets 33, targeted and suggested pricing database 34, and a vehicle pricing normalization engine 35.

The dealership pricing database 31 may include dealership prices for particular vehicle trims as well as vehicle trims plus options. Options may include any add-ons to a vehicle that may be available. The dealership pricing database 31 may include dealership prices for the dealer accessing the dealer portal 30 as well as prices from other dealerships.

The manufacturer vehicle pricing database 32 may include manufacturer prices for various vehicle trims as well as vehicle trims plus options. A manufacturer's price may include a manufacturer's suggested retail price (MSRP) for particular vehicle trims and available options or other manufacturer prices such as inventory prices at which manufacturers may sell to dealerships. The manufacturer vehicle pricing database 32 may be in communication with a vehicle configuration and manufacture pricing collection engine 36, which gather manufacturer prices and update the manufacturer vehicle pricing database as prices may change.

The market vehicle data sets 33 may include market pricing information gathered from multiple sources, such as a vehicle pricing management system and other sources. The market vehicle data sets 33 may be in communication with a vehicle Internet market pricing collection engine 37, which may incorporate how a market for a particular vehicle behaves. It may collect data on market conditions from multiple sources. It may also include data which may allow the vehicle pricing management system to provide pricing feedback to the dealer, where such data may include the ratio between the vehicle pricing to the effect on the leads, walk-ins to the dealerships, and close rate of the perspective buyer based on a set price.

The vehicle configuration and manufacture pricing collection engine 36 and the vehicle Internet market pricing collection engine 37 may be constantly collecting information from multiple sources. The collection engines may be searching the Internet for additional pricing information to enable pricing data to be updated in real-time.

The targeted and suggested pricing database 34 may provide the dealer portal 30 with suggested prices for various vehicle trims and any added options. For example, a target or suggested price may be a price that is identified as the highest yield price. In some instances, a vehicle pricing management system may offer one or more target or suggested price, where each target or suggested price may reflect a different criteria. For example, the system may provide a suggested price for the highest overall yield price, the highest volume price, the highest yield per vehicle price, and so forth. The targeted and suggested prices may vary for different geographic locations. The targeted and suggested prices may incorporate relevant pricing data collected. Relevant pricing data may include dealership prices, manufacturer prices, additional charges, market vehicle data, and information about vehicle leads and sales.

The vehicle pricing normalization engine 35 may communicate with a vehicle lead and sales database 38 and a dealer price change request queue 39. The vehicle lead and sales database 38 may include data about leads and corresponding sales. This data may enable the vehicle pricing manager to provide feedback to a dealer as to the ratio between a vehicle price to the effect of the price on leads, walk-ins to dealerships, and close rate of perspective buyers for a given price. The dealer price change request queue 39 may include dealer requests to change upfront prices displayed to consumers. The dealer may also request other changes relating to what information is revealed, such as whether price incentives may be visible to consumers, or whether to block certain vehicles from being displayed with pricing.

The vehicle pricing normalization engine 35 may normalize the data it receives, including data from the multiple sources so that the information has a standard format, which may make it easier to compare and match vehicle prices. The vehicle pricing normalization engine 35 may also receive pricing information and examine different criteria. It may provide the dealer portal 30 with the various pricing information along with any analysis to assist the dealership with pricing.

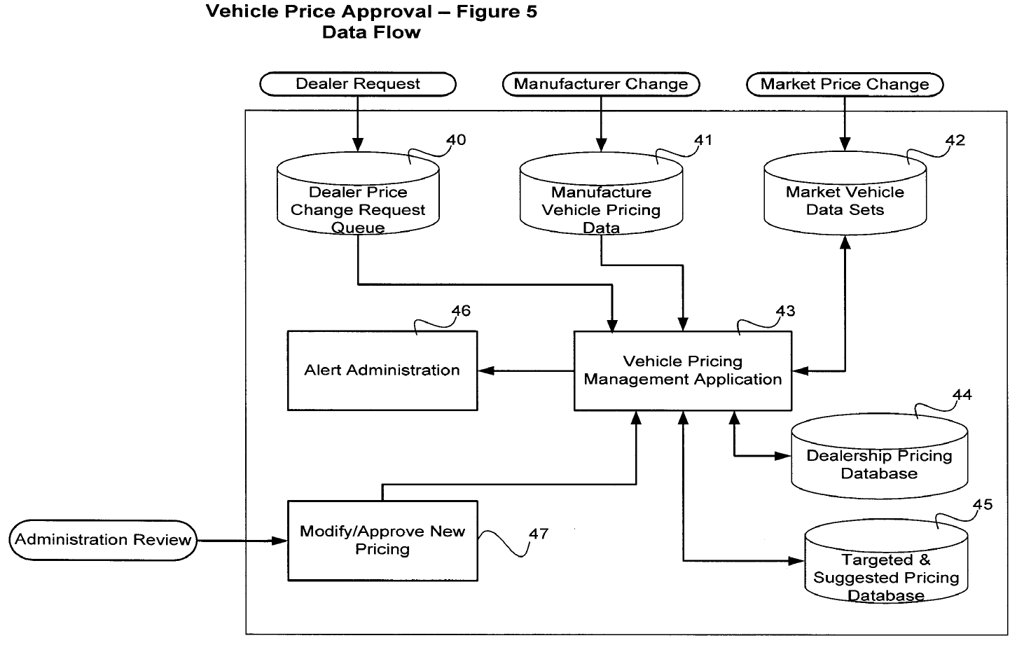

FIG. 5 illustrates data flow for pricing change within a vehicle pricing management system. A vehicle pricing management system may interact with dealers, manufacturers, the market, and vehicle pricing management administration. Pricing changes may occur as a result of changes made by dealers, manufacturers, and the market. A dealer may submit a request to change the price of a vehicle to the vehicle pricing management system. A request for price change may be stored in a dealer price change request queue 40. A dealer may also request other changes, such as what information is visible to a consumer. The vehicle pricing management system may also be constantly collecting manufacturer price information. When a manufacturer may change a price for a vehicle trim or for additional options, this change may be reflected in a manufacture vehicle pricing database 41. The vehicle pricing management system may also be collecting market pricing information, which may be constantly changing. Market price change may be reflected in a market vehicle data set 42. The dealer price change request queue 40, the manufacture vehicle pricing data 41, and market vehicle data sets 42 may be in communication with a vehicle pricing management application 43.

The vehicle pricing management application 43 may also communicate with a dealership pricing database 44, a targeted and suggested pricing database 45, and vehicle pricing management administration. The dealership pricing database may contain dealership prices for particular vehicle trims. This may include dealership prices for a dealer accessing the dealer portal as well as other dealerships. The targeted and suggested pricing database 45 may provide the dealer with suggested prices for various vehicle trims. Any changes in dealership prices, manufacturer prices, or market data may affect the targeted or suggested prices. The vehicle pricing management application 43 may incorporate and keep track of all this information.

If a change in any price occurs, the vehicle pricing management application may alert the vehicle pricing management administration in an alert application 46. The alert application 46 may also inform a system user that may be interested in a price change. For instance, the alert application 46 may inform only a pricing administrator of the vehicle pricing management system of the price change. Alternatively, the system may also inform other parties, such as a dealership or a consumer, about any change in any vehicle price that they may have indicated an interest in. Such changes may come from various sources including, but not limited to, changes by dealers, manufacturers, or the market.

The alert application may inform interested parties of a price change automatically. An interested party may have indicated interest in the vehicle price, whether the interested party indicated an interest for the specific vehicle category, or a broader vehicle category, a geographic location, or for a dealership. Alternatively, the alert application may inform interested parties of a price change if it approved by another party, whether the price change alert is approved by a pricing administrator of a vehicle pricing management system, or a dealership.

The vehicle pricing management application may also be in communication with a modify/approve new pricing application 47. The vehicle pricing management administration, which may include a pricing administrator, may review a dealer price change request. If the price change is approved, it may be reflected in the dealership pricing database, which may affect other pricing information. During administration review of a price change request, the administration may add special notations for certain circumstances. For example, the administration may wish to tag for exceptional situations, such as if a new price is exceptionally high or low, or if a vehicle is very rare or hard to obtain. The administration may post notes back to the dealer.

The vehicle pricing management application 43 may also perform other functions such as administering additional fees associated with a vehicle, such as destination charges, advertising fees, docking fees, and other dealership fees. The vehicle pricing management application 43 may also administer information regarding price incentives that may apply to a vehicle before the final price of the vehicle is calculated. Some of the incentives may be visible to a consumer on the web site; some incentives may be hidden from the consumer, as a special arrangement between the manufacturer and the dealership. In some cases, a dealership may specify whether to display information about incentives to consumers. The vehicle pricing management application 43 may also have the ability to block certain vehicles from being displayed with pricing to a consumer upon dealer request, or the dealer's inability to provision the vehicle at a competitive price.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of vehicle pricing management comprising:
collecting vehicle pricing information from multiple sources for a vehicle category, including at least one of dealership data sources, manufacturer data sources, and market data sources;
receiving an upfront dealership price for the vehicle category from a dealership; and
displaying the upfront dealership price for the vehicle category to a consumer

2. The method of claim 1 further comprising suggesting a target price to a dealership for the vehicle category.

3. The method of claim 1 further comprising:
receiving a request to change or modify the upfront dealership price; and
determining whether to modify the upfront dealership price.

4. The method of claim 1 further comprising notifying interested parties of a change in price of a vehicle category.

5. The method of claim 1 further comprising calculating additional fees associated with a vehicle.

6. The method of claim 1 wherein additional fees associated with a vehicle includes at least one of: destination charges, advertising fees, or docking fees.

7. The method of claim 1 wherein the target price is the highest yield pricing.

8. The method of claim 1 further comprising providing a guarantee that the upfront dealership price is not greater than the market average price.

9. A vehicle pricing management system comprising:
a vehicle pricing management application capable of:
receiving vehicle pricing information from one or more sources for a vehicle model or trim; and
providing an upfront dealership price for the vehicle model or trim.

10. The system of claim 9 further comprising suggesting a target price to a dealership for a vehicle model or trim.

11. The system of claim 9 wherein one or more sources includes at least one of dealership data sources, manufacturer data sources, and market data sources.

12. The system of claim 9 wherein the vehicle pricing management application is capable of blocking a dealership's price from being displayed to a consumer.

13. The system of claim 9 wherein the vehicle pricing management application is capable of showing incentive information to a consumer.

14. The system of claim 9 wherein the target price is based on the vehicle pricing information from one or more sources.

15. The system of claim 9 wherein providing the upfront dealership price includes providing a price guarantee that the upfront dealership price is not more than the market average price.

16. A method of vehicle pricing management comprising:
receiving a dealership price of a vehicle category from a dealership; and
displaying an upfront dealership price of a vehicle category to a consumer on a website.

17. The method of claim 16 further comprising:
suggesting a target price to a dealership for the vehicle category.

18. The method of claim 16 wherein the website is owned or operated independent of a dealership or dealership parent company.

19. The method of claim 17 wherein the suggested target price is based on vehicle pricing information from multiple sources for the vehicle category, including at least one of dealership data sources, manufacturer data sources, and market data sources.

20. The method of claim 16 wherein the displayed upfront dealership price depends on the geographic location of the consumer.

21. The method of claim 16 wherein the upfront dealership price is the dealership price.

22. The method of claim 16 wherein the upfront dealership price is not greater than the market average price.

23. A vehicle pricing management system comprising:
an independently owned server; and
a vehicle pricing management application running on the server capable of receiving vehicle pricing information from one or more sources and for providing an upfront dealership price for a vehicle trim.

24. The system of claim 23 further comprising a dealer portal in communication with the vehicle pricing management application wherein the dealer portal provides dealerships with secure access to pricing information.

25. The system of claim 23 further comprising a vehicle pricing administration application which is part of the vehicle pricing management application, wherein the vehicle pricing administration application incorporates additional fees associated with a vehicle.

26. The system of claim 25 wherein the additional fees associated with a vehicle include at least one of: destination charges, advertising fees, or docking fees.

27. The system of claim 23 further comprising a pricing normalization engine which is part of the vehicle pricing management application wherein the pricing normalization engine is capable of normalizing data from multiple sources.

28. The system of claim 23 wherein a change in vehicle pricing information from one or more of the sources is considered by the vehicle pricing management application.

29. The system of claim 28 wherein the change in vehicle pricing information changes the upfront dealership price for the vehicle trim.

30. A computer readable medium containing program instructions for creating a computer identifier in the course of an online transaction comprising:
computer code that receives vehicle pricing information from one or more sources;
computer code that receives a dealership price for a vehicle model or trim from the dealership; and
computer code that displays an upfront dealership price for the vehicle model or trim.

31. The computer readable medium of claim 30 further comprising computer code that suggests a target price to a dealership for a vehicle model or trim.

32. The computer readable medium of claim 30 wherein the upfront dealership price is the dealership price.

33. The computer readable medium of claim 30 wherein the upfront dealership price is the dealership price plus any additional fees associated with the vehicle model or trim.

34. The computer readable medium of claim 30 wherein the target price is based on the vehicle pricing information from one or more sources.
